(19) United States
(12) Patent Application Publication
(10) Pub. No.: US 2023/0032880 A1
(43) Pub. Date: Feb. 2, 2023

(54) ELEVATOR DOOR LEAF AND ELEVATOR SYSTEM

(71) Applicant: WITTUR HOLDING GMBH, 85259 WIEDENZHAUSEN, BAYERN (DE)

(72) Inventor: PAOLO GIORGIONI, VENTASSO (IT)

(21) Appl. No.: 17/791,299

(22) PCT Filed: Jul. 14, 2021
(86) PCT No.: PCT/IB2021/056345

§ 371 Date: Jul. 7, 2022

(30) Foreign Application Priority Data
Jul. 20, 2020 (IT) 202020000004324

(51) Int. Cl. B66B 13/30

(52) U.S. Cl. CPC B66B 13/303

(57) ABSTRACT

An elevator door leaf (1) comprising: a panel (2); at least one reinforcement profile (3) fixed to the panel (2). The reinforcement profile (3) is made of carbon fibre.

### TECHNICAL FIELD

The present invention relates to an elevator door leaf and an elevator system.

### BACKGROUND ART

In the sector of elevators, solutions of the known type mainly use door leaves composed of metal sheets (generally carbon steel or stainless steel) of various thicknesses with metal reinforcement elements welded or glued onto the base metal sheet so that the door leaf has mechanical resistance that complies with legislation in force.

In special applications the use of a door leaf entirely made of carbon fibre is known, in order to enable a notable reduction in weight. Such solution implies several difficulties in production terms (autoclave, moulds, format change problems, etc.).

### DISCLOSURE OF THE INVENTION

In this context, the technical task that is the basis of the present invention is to propose an elevator door leaf and an elevator system that overcome the drawbacks of the cited prior art.

In particular, the aim of the present invention is to propose an elevator door leaf which is light but at the same time resistant.

The technical task set and the objects specified are substantially attained by an elevator door leaf according to one or more of the appended claims.

### BRIEF DESCRIPTION OF DRAWINGS

Further characteristics and advantages of the present invention will become more apparent from the indicative and thus non-limiting description of a preferred, but not exclusive, embodiment of an elevator door leaf and an elevator system, as illustrated in the appended drawings, in which:

FIG. 1 illustrates an embodiment of an elevator door leaf, according to the present invention, in a partially exploded perspective view;

FIG. 2 illustrates a detail (fixing of the support to the header) of the door leaf of FIG. 1, according to one embodiment;

FIG. 3 illustrates a detail (fixing of the support to the header) of the door leaf of FIG. 1, according to an alternative embodiment;

FIG. 4 illustrates an alternative embodiment of an elevator door leaf, in a partially exploded perspective view;

FIG. 5 illustrates a detail (fixing of the support to the panel) of the door leaf of FIG. 4, according to one embodiment;

FIG. 6 illustrates a detail (fixing of the support to the panel) of the door leaf of FIG. 4, according to an alternative embodiment.

### DETAILED DESCRIPTION OF PREFERRED EMBODIMENTS OF THE INVENTION

With reference to the figures, reference numeral 1 indicates an elevator door leaf.

The door leaf 1 comprises a panel 2 and at least one reinforcement profile 3 fixed to the panel 2. The reinforcement profile 3 is made of carbon fibre. Preferably, the panel 2 is made of metallic material. Preferably, the panel 2 is made of aluminium.

According to one embodiment, the reinforcement profile 3 has an omega shaped cross section.

According to one embodiment, the reinforcement profile 3 is a hollow tube. Preferably, the panel 2 has a prevalently planar extension along a first direction and a second direction orthogonal to each other. In other words, it has two prevalent extension components: a length (or height) and a width. The extension of the panel 2 along a transverse direction with respect to the plane, also known as the thickness of the panel 2, is very reduced with respect to the other two dimensions.

Preferably, the panel 2 is substantially rectangular.

The reinforcement profile 3 has an elongated extension according to a substantially parallel direction to the first or second direction.

Preferably, the door leaf 1 comprises at least one support 4 fixed to the panel 2 and having a substantially orthogonal extension to the extension of the reinforcement profile 3. The support 4 defines at least one housing 5 for an end of the reinforcement profile 3.

In the embodiment described and illustrated herein, the door leaf 1 comprises two parallel supports 4 fixed to the panel 2 and having a substantially orthogonal extension to the extension of the reinforcement profile. Each of the supports 4 defines at least one housing 5 for an end of the reinforcement profile 3.

Preferably, a plurality of reinforcement profiles 3 is fixed to the panel 2. The supports 4 define a plurality of housings 5 in which the corresponding ends of the reinforcement profiles 3 are arranged.

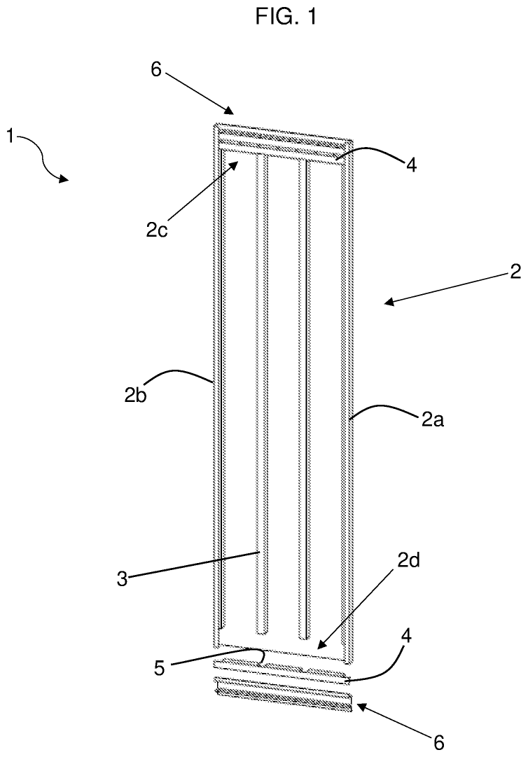

According to one embodiment, illustrated in FIG. 1, the reinforcement profile 3 has an extension according to a substantially parallel direction to the length of the panel 2.

Preferably, a plurality of reinforcement profiles 3 have an extension according to a plurality of directions substantially parallel to the length of the panel 2.

Preferably, the support 4 has an extension along the width of the panel 2 and has housings 5 equal to the number of reinforcement profiles 3 that are coupled therewith.

Preferably, the door leaf 1 comprises two supports 4 arranged respectively at an upper end 2c and at a lower end 2d of the panel 2 so that both the lower and upper ends of the reinforcement profiles 3 are housed in the supports 4.

Preferably, the door leaf 1 comprises two headers 6 mounted respectively at the upper end 2c and a lower end 2d of the panel 2.

The header 6 is a profile of the known type and is used for fixing the door leaf 1 to a mechanism of a door and/or sliding shoes.

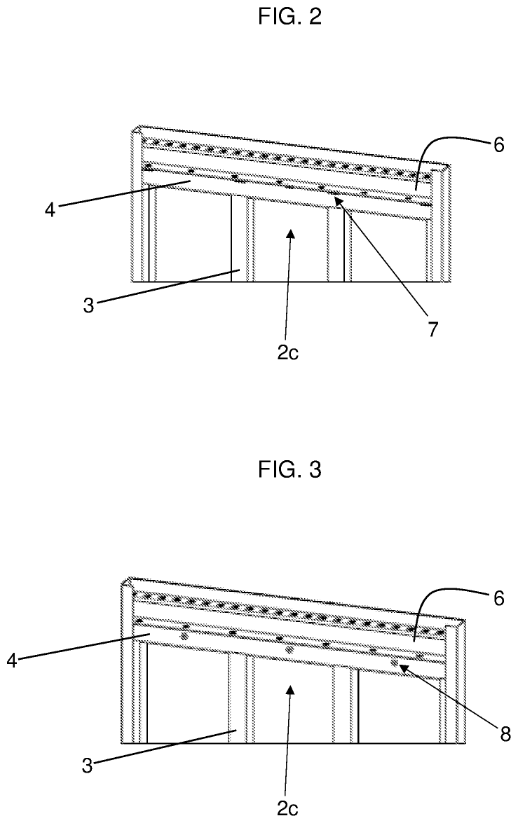

According to one embodiment, illustrated in FIG. 2, each support 4 is welded to the corresponding header 6. In particular, each support 4 is fixed to the corresponding header 6 by one or more spot welds 7.

According to an alternative embodiment, illustrated in FIG. 3, each support 4 is fixed to the corresponding header 6 by riveting. In particular, each support 4 is fixed to the corresponding header 6 by one or more rivets 8.

According to a further alternative embodiment (not illustrated), each support 4 is fixed to the corresponding header 6 by adhesive means.

According to another embodiment (not illustrated), each support 4 is fixed to the corresponding header 6 by jointing.

Preferably, the reinforcement profiles 3 are equidistant according to the width of the panel 2.

According to an alternative embodiment, the reinforcement profile 3 has an extension according to an inclined direction with respect to the length of the panel 2. In other words, the reinforcement profile 3 has an extension component along the width of the panel 2.

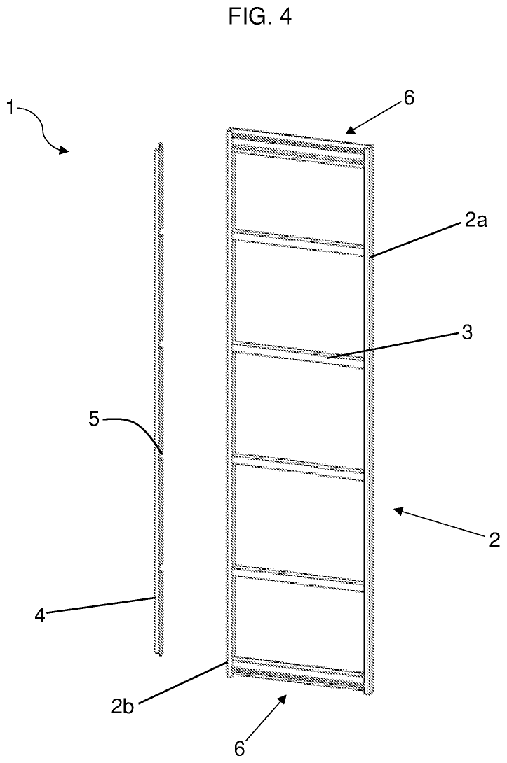

Preferably, as illustrated in FIG. 4, the reinforcement profile 3 has an extension according to the width of the panel 2. In particular, the reinforcement profile 3 extends substantially horizontally.

Preferably, the reinforcement profile 3 has an extension between two opposite sides of the panel 2 according to the width.

Preferably, a plurality of reinforcement profiles 3 having an extension according to the width are arranged along the panel 2.

Preferably, the support 4 has an extension along the width of the panel 2 and has a plurality of housings 5 equal to the number of reinforcement profiles 3.

Preferably, the door leaf 1 comprises two supports 4 fixed respectively to two opposite lateral edges 2a, 2b of the panel 2.

Preferably, the lateral edges 2a, 2b of the panel 2 are folded onto themselves inwards. For example, the lateral edges are folded in a C shape. Lateral edges mean the sides of the panel 2 having an extension according to the length (or height).

Each of the supports 4 has ends fixed inside the opposite folded lateral edges 2a, 2b, respectively.

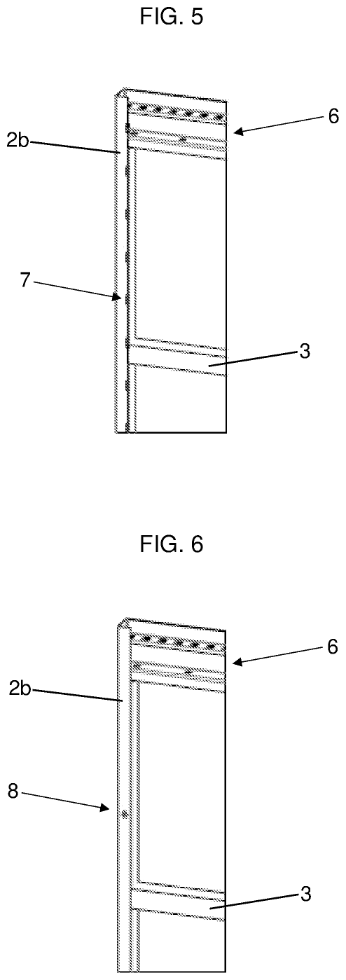

According to one embodiment, illustrated in FIG. 5, the support 4 is welded to the panel 2 by one or more spot welds 7.

According to an alternative embodiment, illustrated in figure O, the support 4 is fixed to the panel 2 by one or more rivets 8.

According to a further alternative embodiment (not illustrated), the support 4 is fixed to the panel 2 by adhesive means.

According to another embodiment (not illustrated), the support 4 is fixed to the panel 2 by jointing.

Preferably, the reinforcement profiles 3 are equidistant according to the height of the panel 2.

According to one embodiment (not illustrated), the door leaf 1 comprises a plurality of reinforcement profiles 3 arranged according to a plurality of parallel and/or transverse directions to the length of the panel 2.

The subject matter of the present invention is an elevator system, described below.

The elevator system (not illustrated) comprises a cage slidable in a shaft. The cage comprises at least one door leaf 1 according to what is described above.

Preferably, the elevator system comprises a landing door comprising at least one door leaf 1 according to the above description.

The characteristics of the elevator door leaf and elevator system according to the present invention emerge clearly from the above description, as do the advantages.

The use of carbon fibre reinforcement profiles enables the thickness of the panel to be notably reduced or light and less resistant materials to be used for it, such as, for example, aluminium, without compromising the mechanical resistance of the door. Furthermore, the use of carbon fibre only for the reinforcement profiles greatly simplifies the production of the door leaf with respect to the solution that envisages an entirely carbon fibre door leaf.

In particular, the combined use of aluminium for the panel and carbon fibre for the reinforcement profiles is particularly advantageous. In fact, the use of carbon fibre reinforcement profiles maintains the lightness of the door leaf typical of aluminium, but the resistance of carbon fibre enables the ductility of aluminium to be compensated. A light but resistant door leaf is particularly important for obtaining greater capacity of the elevator system. Capacity means herein the number of people moved in relation to the same number of mechanical components.

With a lighter door leaf it is possible to resort to a door-opening motor with lower power with respect to known solutions, with consequent energy savings.

1. An elevator door leaf comprising:
a panel;
at least one reinforcement profile fixed to the panel,
said at least one reinforcement profile being made of carbon fibre.

2. The door leaf according to claim 1, wherein the panel has a prevalently planar extension along a first direction and a second direction orthogonal to one another, said at least one reinforcement profile having an elongated extension according to a substantially parallel direction to said first direction or to said second direction.

3. The door leaf according to claim 1, wherein said at least one reinforcement profile is a hollow tube.

4. The door leaf according to claim 1, wherein said at least one reinforcement profile has an omega shaped cross section.

5. The door leaf according to claim 1, comprising two parallel supports fixed to the panel and having a substantially orthogonal extension to the extension of said at least one reinforcement profile, each of said supports defining at least one housing for an end of the reinforcement profile.

6. The door leaf according to claim 5, comprising two headers mounted respectively at an upper end and a lower end of the panel, each of said supports being fixed to a corresponding header.

7. The door leaf according to claim 6, wherein each support is fixed to the corresponding header by one or more spot welds.

8. The door leaf according to claim 6, wherein each support is fixed to the corresponding header by one or more rivets.

9. The door leaf according to claim 6, wherein each support is fixed to the corresponding header by adhesive means.

10. The door leaf according to claim 6, wherein each support is fixed to the corresponding header by jointing.

11. The door leaf according to claim 5, wherein the panel comprises opposite folded lateral edges, each of said supports having ends fixed to the inside of the opposite folded lateral edges respectively.

12. The door leaf according to claim 1, wherein the panel has a prevalently planar extension along a first direction and a second direction orthogonal to each other, said at least one reinforcement profile having an elongated extension according to a substantially inclined direction to said first direction and to said second direction.

13. The door leaf according to claim 1, comprising a plurality of reinforcement profiles parallel to one another and fixed to the panel, each of said reinforcement profiles having an extension according to a substantially parallel direction to said first direction or to said second direction.

14. The door leaf according to claim 13, wherein the reinforcement profiles are equidistant.

15. The door leaf according to claim 1, wherein said panel is made of metallic material.

16. The door leaf according to claim 15, wherein said panel can be made of aluminium.

17. An elevator system, comprising a cage slidable in a shaft, said cage comprising a door leaf according to claim 1.

18. The elevator system according to claim 17, comprising a landing door comprising a door leaf, said door leaf comprising:
a panel;
at least one reinforcement profile fixed to the panel,
said at least one reinforcement profile being made of carbon fibre.
